(19) United States
(12) Patent Application Publication
(10) Pub. No.: US 2017/0307782 A1
(43) Pub. Date: Oct. 26, 2017

(54) GRADIENT-OPTICAL-INDEX POROUS (GRIP) COATINGS BY LAYER CO-DEPOSITION AND SACRIFICIAL MATERIAL REMOVAL

(71) Applicants: The University Of North Carolina At Charlotte, Charlotte, NC (US); The Government of the United States of America, as represented by the Secretary of the Navy, Arlington, VA (US)

(72) Inventors: Menelaos K. POUTOUS, Harrisburg, NC (US); Ishwar D. AGGARWAL, Waxhaw, NC (US); Abigail H. PELTIER, Charlotte, NC (US); Lynda E. BUSSE, Alexandria, VA (US); Jesse FRANTZ, Washington, DC (US); L. Brandon SHAW, Woodbridge, VA (US); Jas S. SANGHERA, Ashburn, VA (US)

(21) Appl. No.: 15/493,808

(22) Filed: Apr. 21, 2017

Related U.S. Application Data
(60) Provisional application No. 62/325,539, filed on Apr. 21, 2016.

(51) Int. Cl. G02B 1/113; C03C 15/00; C03C 17/245

(52) U.S. Cl. CPC G02B 1/113; C03C 17/245; C03C 15/00; C03C 2217/732; C03C 2217/214

(57) ABSTRACT

The present invention provides a specific gradient-optical-index porous (GRIP) layer coating on inorganic optical substrate surfaces, and the fabrication method used to create the GRIP layer coating. The method consists of two major processing steps: (1) the co-deposition of an optical index-matching material and a mass density-modulating material, followed by (2) the sacrificial etch of the mass-density-modulating material to reveal a GRIP surface. The method is designed for use with crystalline, polycrystalline, and dry or wet etch-resistant substrate materials, where anti-reflective (AR) solutions using AR surface structures (ARSSs) do not exist. These coatings are designed to minimize Fresnel reflectivity of the original substrate surfaces, using a single porous layer matched to the optical index of the original substrate material.

### CROSS-REFERENCE TO RELATED APPLICATION

The present patent application/patent claims the benefit of priority of co-pending U.S. Provisional Patent Application No. 62/325,539, filed on Apr. 21, 2016, and entitled “GRADIENT-OPTICAL-INDEX POROUS (GRIP) COATINGS BY LAYER CO-DEPOSITION AND SACRIFICIAL MATERIAL REMOVAL,” the contents of which are incorporated in full by reference herein.

### STATEMENT OF GOVERNMENT SUPPORT

The present invention was made with U.S. Government support by the Naval Research Laboratory, Award No. N0017312-1-G020. Accordingly, the U.S. Government has certain rights in the present invention.

### FIELD OF THE INVENTION

The present invention relates generally to anti-reflective (AR) coatings. More specifically, the present invention relates to systems and methods for producing gradient-optical-index porous (GRIP) coatings by layer co-deposition and sacrificial material removal.

### BACKGROUND OF THE INVENTION

The direct nano-patterning of the surface of an optical element to achieve reduced Fresnel reflections is an attractive alternative to traditional AR coatings. Unlike thin-film multi-layered coatings, this anti-reflective surface structure (ARSS) processing does not involve applying additional materials to the surface of the optics, which often results in coating delamination under thermal cycling and laser damage to the coating at lower thresholds than the window material. In contrast, state-of-the-art processing has resulted in AR performance of ARSSs comparable to that of the traditional AR coatings, while adding significant advantages, such as higher laser damage thresholds, large acceptance angles, and ease of cleaning, since there is no foreign material on the surface. Random ARSSs can be designed to work over large bandwidths with a variety of materials and have been shown to exhibit high laser damage thresholds. The scale of the random pattern utilized is designed to be in the optical sub-wavelength regime in order to avoid undesired diffraction and/or scattering effects, while the height of the individual features is on the order of one-half the optical wavelength in order to simulate a layer with graded index variation, between that of air and the optical substrate. For random-ARSSs (rARSSs), nano-structuring is typically performed using dry-etching-based methods. Lithographic steps are not needed for rARSSs, and the optical surface is typically processed with reactive ion etching, using plasma and gas mixtures appropriate to the substrate material.

Certain crystalline inorganic materials used for optical applications, such as Sapphire, Germanium, Zinc Sulfide, Zinc Selenide, Calcium Fluoride, and Diamond, have dry (and sometimes wet) etch resistance, as they do not react with etching plasmas, such as Methyl Fluoride, Ethyl Fluoride, Freon, Sulfur-hexafluoride, Oxygen, Chlorine, Boron tri-Chloride, and Hydrogen, or they can react destructively, thus rendering the fabrication of rARSSs impossible with currently known methods and technologies. For these types of optical substrates, there are no rARSSs demonstrated to date. The same applies for polycrystalline and compressed powder substrates, such as various grades of Spinel, Zerodur, and Cleartran. The large index of refraction of these materials (which can vary from 1.5 to 4.0), across their respective application wavelengths (from 150 nm to 20 μm), limits the transmission performance of optical elements and windows fabricated using them. Conventional AR thin-film layered coatings are used to reduce their reflectivity, leading to the issues mentioned previously.

The ability to fabricate rARSSs on etch-resistant optical substrates would enable the technology to apply beyond vitreous substrates (such as fused silica and glasses), in spectral regions where conventional solutions are currently not available.

### BRIEF DESCRIPTION OF THE INVENTION

In various exemplary embodiments, the present invention provides a specific GRIP layer coating on inorganic optical substrate surfaces, and the fabrication method used to create the GRIP layer coating. The method consists of two major processing steps: (1) the co-deposition of an optical index-matching material and a mass density-modulating material, followed by (2) the sacrificial etch of the mass-density-modulating material to reveal a GRIP surface. The method is designed for use with crystalline, polycrystalline, and dry or wet etch-resistant substrate materials, where AR solutions using ARSSs do not exist. These coatings are designed to minimize Fresnel reflectivity of the original substrate surfaces, using a single porous layer matched to the optical index of the original substrate material.

In one exemplary embodiment, the present invention provides a method for forming a gradient-optical-index porous anti-reflective coating, comprising: providing a substrate; depositing an optical index matching material on the substrate, wherein an optical index of the optical index matching material is substantially the same as an optical index of the substrate; co-depositing a sacrificial material on the substrate and the optical index matching material to modulate the mass density of the optical index matching material in an intermixing layer between the optical index matching material and the sacrificial material, wherein the intermixing layer has a gradient optical index matching material composition; and etching the sacrificial material and a portion of the intermixing layer to form a porous, random, gradient optical index surface on the substrate. The depositing and co-depositing steps are performed in a vacuum. Optionally, the depositing and co-depositing steps comprise physical deposition steps. In the intermixing layer, the optical index matching material has a higher mass density adjacent to the optical index matching material and the substrate than adjacent to the sacrificial material. The sacrificial material forms a cap layer comprising only sacrificial material adjacent to the intermixing layer. Optionally, etching the sacrificial material and a portion of the intermixing layer comprises randomly etching the sacrificial material and a portion of the intermixing layer. The substrate comprises an inorganic optical substrate. More specifically, the substrate comprises one of a crystalline, a polycrystalline, a dry, and a wet etch-resistant substrate. Optionally, etching the sacrificial material and a portion of the intermixing layer comprises ion-etching the sacrificial material and a portion of the intermixing layer. Optionally, the optical index of the optical index matching material is substantially different from an optical index of the sacrificial material.

In another exemplary embodiment, the present invention provides a gradient-optical-index porous anti-reflective coating formed by a process, comprising: providing a substrate; depositing an optical index matching material on the substrate, wherein an optical index of the optical index matching material is substantially the same as an optical index of the substrate; co-depositing a sacrificial material on the substrate and the optical index matching material to modulate the mass density of the optical index matching material in an intermixing layer between the optical index matching material and the sacrificial material, wherein the intermixing layer has a gradient optical index matching material composition; and etching the sacrificial material and a portion of the intermixing layer to form a porous, random, gradient optical index surface on the substrate. The depositing and co-depositing steps are performed in a vacuum. Optionally, the depositing and co-depositing steps comprise physical deposition steps. In the intermixing layer, the optical index matching material has a higher mass density adjacent to the optical index matching material and the substrate than adjacent to the sacrificial material. The sacrificial material forms a cap layer comprising only sacrificial material adjacent to the intermixing layer. Optionally, etching the sacrificial material and a portion of the intermixing layer comprises randomly etching the sacrificial material and a portion of the intermixing layer. The substrate comprises an inorganic optical substrate. More specifically, the substrate comprises one of a crystalline, a polycrystalline, a dry, and a wet etch-resistant substrate. Optionally, etching the sacrificial material and a portion of the intermixing layer comprises ion-etching the sacrificial material and a portion of the intermixing layer. Optionally, the optical index of the optical index matching material is substantially different from an optical index of the sacrificial material.

### BRIEF DESCRIPTION OF THE DRAWINGS

The present invention is illustrated and described herein with reference to the various drawings, in which:

FIG. 1 (top row) shows refractive index profiles for three cases of interference between materials A and B—(left) a discontinuous single boundary, where the index changes abruptly from nA to nB, (middle) a four-layer coated surface, with intermediate index values, and (right) a gradient-index layered interface; and (bottom)—the physical layout of the materials and boundary regions corresponding to the index cases provided above;

FIG. 2 shows one exemplary embodiment of the four sequential steps used to form the GRIP layer coating of the present invention on an inorganic optical substrate surface, including: (a) physical vapor deposition of the optical index-matching material on the substrate; (b) physical vapor co-deposition of the optical index-matching material and the sacrificial material; (c) ending the physical vapor deposition cycle with a sacrificial material cap; and (d) sacrificial etching of the material using reactive-ion plasma in a vacuum; and

FIG. 3 shows: (a) a micrograph of a typical rARSS fabricated using the methods of the present invention (the top insert is a high-magnification electron-microscope image with the nanostructured random surface being partially shown); and (b) optical test results from sequentially deeper etching of the sacrificial layer, forming the GRIP effect (the more sacrificial material is removed, the higher the transmission of the substrate becomes, with the original transmission shown in black)—note, the material used is Spinel, which has a high resistivity to direct reactive-ion-etch.

### DETAILED DESCRIPTION OF THE INVENTION

The present invention is based on the AR properties of a randomly structured optical surface. The goal of the present invention is to significantly reduce the Fresnel reflections created by the boundary discontinuity between an optical substrate and the surrounding medium, which is air, for example. The novelty is in the surface structure fabrication, which is applicable to etch-resistant materials.

Gradient-index interfaces are used as spectral filters, broad-band AR (BBAR) coatings, and polarization insensitive coatings, for example. The optical function response corresponds to the optical index profile, and the fabrication of the optical index layer(s) is achieved using the following exemplary methods:
(a) Oblique-Angle and Glancing-Angle Sputtering or Physical Vapor Deposition (GLAD),
(b) Sputtering or Physical Vapor Co-Deposition (PVD),
(c) Dynamic Plasma Reactive Ion Etching or Inductively Coupled Plasma Reactive Ion Etching in a Vacuum (ICP/RIE),
(d) Wet Chemical Etching or Leaching,
(e) Sol-Gel Deposition and Structuring,
(f) Layer-by-Layer Nanocomposite Aqueous Deposition, and
(g) Growth of Nano-Rods, Nano-Wires, or Other Nanostructures.

These fabrication techniques can be grouped in larger categories, such as:
(i) Physical Deposition of Material(s) on the optical substrate (a and b),
(ii) Substrate Material Removal (c and d),
(iii) Chemical Deposition (e and f), and
(iv) Surface Growth at the nanometer scale (g).

The present invention addresses anti-reflectivity for materials that are resistant to fabrication technique (ii), produce weak or fragile coatings using fabrication techniques (i), (iii), and (iv), and are used in optical component applications, from the ultraviolet (UV) (200 nm) to the long-wavelength infrared (LWIR) (20 μm), for example.

Optical components for optical beam delivery systems include lenses, prisms, optical flats, windows, beam-splitters, waveplates, polarizers, and filters. In all cases, the light wavefront crosses interfaces between media that are planar and/or curved. All physical boundaries between materials act as optical interfaces. The effects that are observed as a light beam of certain dimensions and with certain intensity crosses an interface could be scattering, diffusion, reflection, absorption, and/or transmission. In real applications, a combination of all of the above is observed to a certain degree. The collective macroscopic physical quantity used to describe the optical mismatch between materials across interfaces is the difference in optical refractive index. The optical admittance between two media separated by a boundary (i.e. interface) is the product of the refractive index and the cosine of the direction of the beam with respect to the boundary. In cases of polarized light beams, the admittance is different for different polarization directions with respect to the boundary normal. As the optical beam crosses the boundary, the boundary effects mentioned above will influence the propagation of the wavefront and the transfer of light intensity. In general, optical path components are engineered to transfer a light beam in specific directions, with minimal losses. Considering that goal, any deviation of the optical beam from the desired direction, or any change induced in the uniformity or intensity of the beam, as it crosses boundaries can be classified as a loss. Scattering in the forward and reverse incident directions, as well as diffuse scattering are considered losses.

In many cases, in order to suppress a boundary crossing effect, material interfaces are layered. One such example is the multi-layered interference coating, used to create high-reflectivity components, or nullify reflectivity altogether (i.e. an AR coating (MLAR)). In such a case, the collection of refractive indices of the layers making up the interface is used as an interference filter that can constructively add (or subtract) lightwave contributions as the wavefront propagates through it. Deposition of these layers results in some thermal and mechanical defects and moduli mismatches between the layers themselves and between the layers and the substrate. These defects, caused by the deposition fabrication processes, can increase scattering and redistribute the thermal loading in the coatings. The combination of absorption and material inhomogeneities, or structural defects (e.g. scratches, voids, inclusions, and impurities), are the major contributors to laser damage in optical components, and they are central to the lowering of the damage thresholds of interfaces.

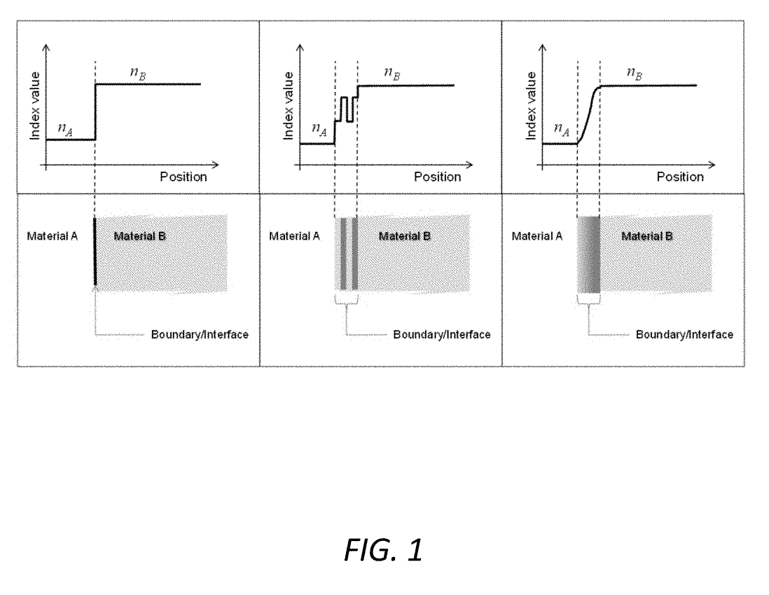

One solution to the minimization of the specular reflection and coherent addition of the fields at the boundaries is the introduction of a gradient-refractive-index interface. Replacing a multilayered coating stack by a gradient-index profile layer has also shown higher damage thresholds in a variety of materials. The principle is illustrated in FIG. 1. The interface layer at the boundary of two optical materials can be engineered to have a gradual refractive index change, resulting in a continuous index value increase (or decrease). This index profile reduces the specular reflectivity over a large spectral range of wavelengths. There are numerous methods to fabricate gradient-index interfaces. In general, they can be divided into two major categories: deposition techniques and etching techniques, outlined as (a) through (g) above.

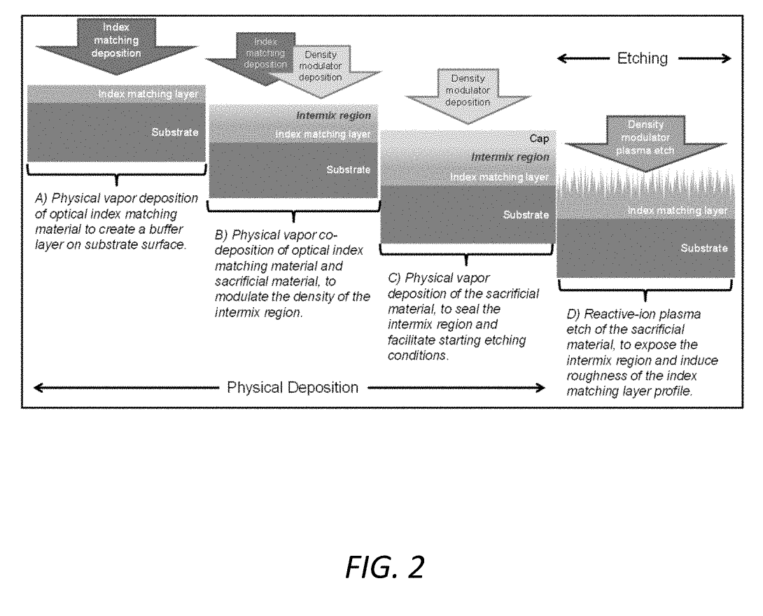

The fabrication technique of the present invention consists of a hybrid method of deposition and etching, using a specific sacrificial layer as a mass density modulator, in order to create a randomly structured surface on a process-incompatible substrate, which in turn will have a gradient-optical-index effect on incident light. The major steps of the fabrication technique are shown in FIG. 2. In detail, the steps include:

(A) The deposition of the optical-index matching material on the substrate is performed first under high-vacuum conditions. This deposition can be achieved by physical methods (i.e. sputtering, electron beam evaporation, thermal evaporation, etc.). The purpose of the deposition is to cover the etch-resistant surface with a layer of material that has the same (or close to the same) optical index as the substrate, and allow adhesion to the substrate. For the materials mentioned, the following may be used:

| Optical substrate material | Optical-index matching layer material |
|---|---|
| Sapphire, Spinel | Aluminum Oxide |
| Germanium | Germanium Oxide |
| Zinc Sulfide, Zinc Selenide | Zinc Oxide |
| Calcium Fluoride | Silica |
| Diamond | Amorphous Diamond |

(B) Without removing the substrate from the vacuum chamber, a second physical vapor deposition source can be activated to modulate the mass density of the depositing optical-index matching material with a compatible sacrificial material. During this step, the deposition of the original material (from step (A)) is reduced according to specific schedules in order to enrich the layer mixture with sacrificial material. The purpose of this step is to disrupt the ordered deposition of the index-matching layer, and induce a randomized mixture that will progressively become deprived of the index matching material. The deposition thus creates an intermixing region, which can be engineered to the desired depth parameter requirement. The sacrificial material is chosen for its etching and physical vapor deposition disruption properties only, without any optical-index matching requirements or considerations.

| Index matching material | Sacrificial intermix material |
|---|---|
| Aluminum Oxide | Silicon Monoxide |
| Germanium Oxide | Silicon |
| Zinc Oxide | Indium Tin Oxide |
| Silica | Silicon Monoxide |
| Amorphous Diamond | Silicon Monoxide |

(C) Continuing the sacrificial material deposition after the original optical-index matching material deposition is terminated results in sealing the co-deposition layer with sacrificial material only. This step is required as an end to the co-deposition (intermixing) process.

(D) Reactive-ion etch (RIE) or Inductively-Coupled RIE (ICP/RIE) is the next step in the fabrication process. The target of this etch step is the removal of the sacrificial top-layer and the intermixed sacrificial material, leaving behind a porous, random, gradient optical-index surface, consisting only of the original optical-index matching material on the substrate. The random depth and density of the remaining layer will introduce gradient-index optical effects on the substrate boundary, leading to the suppression of Fresnel reflection losses, absorption, and scatter.

The above described method has been demonstrated with specific materials, and a representative example is described herein below.

### Example

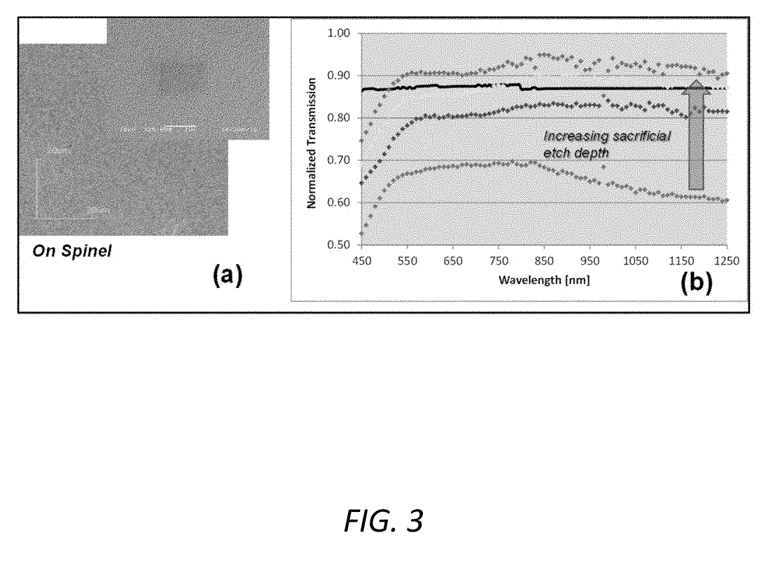

Spinel optical grade planar substrates were coated with aluminum oxide (the index matching material) and silicon monoxide (the sacrificial layer) using the fabrication steps described above. The presence of a material intermix region between the aluminum oxide and the silicon monoxide was verified by optical variable angle spectroscopic ellipsometry. Various co-deposition recipes were attempted and verified. The etching step was performed with a RIE chamber using a mixture of sulfur-hexafluoride and oxygen plasma under vacuum. The sacrificial etch was performed with fixed time intervals and the samples were removed and measured. The measurements included: (a) surface profiling under UV-confocal microscopy (LEXT) and Scanning Electron Microscopy (SEM) and (b) optical transmission spectral measurements using a dual-beam spectrophotometer. FIG. 3 shows representative results from the trials. Nano-porosity was verified in control samples of silicon and silica as well. FIG. 3 shows the evolution of the optical gradient-index effect as a function of sequential etches. The transmission of the Spinel substrate was increased by a net 5-7% across the spectral range from 800 nm to 1200 nm. For a single-sided AR-coated Spinel substrate, the transmission enhancement was around 7%. Thus, the results achieve maximum anti-reflectivity at a 100 nm band between 800 nm and 900 nm wavelength.

Thus, the present invention provides the micro-fabrication of an inorganic, hard, porous coating (GRIP) on optical substrates and components that performs as a gradient-index optical filter, based on a dual deposition and sacrificial etching process, for use from the UV to the IR spectral region.

The GRIP provided is achieved with a novel fabrication process that leverages the sacrificial material two ways: (a) to induce a random mass-density modulation of the index matching deposition and (b) to allow the removal of the sacrificial material in order to result in a random structured surface with specific optical function properties, such as the suppression of reflectivity. The novel process enables the fabrication of AR surfaces on etch resistant substrates that have no current fabrication solutions, other than conventional multilayered thin film coatings.

As contemplated herein, the optical index of the optical index matching material is substantially the same as the optical index of the substrate. By way of example only, in the case of a sapphire crystal or synthetic (extraordinary optical index=1.7478, ordinary optical index=1.7557, at a wavelength of 1.0 μm) and aluminum oxide films (optical index=1.7200, at a wavelength of 1.0 μm). Exemplary thicknesses for the optical index matching layer are on the order of the optical wavelength of the application, for the intermixing layer on the order of twice to thrice the optical wavelength of the application, and for the sacrificial layer on the order of the optical wavelength of the application.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims.

What is claimed is:

1. A method for forming a gradient-optical-index porous anti-reflective coating, comprising:
providing a substrate;
depositing an optical index matching material on the substrate, wherein an optical index of the optical index matching material is substantially the same as an optical index of the substrate;
co-depositing a sacrificial material on the substrate and the optical index matching material to modulate the mass density of the optical index matching material in an intermixing layer between the optical index matching material and the sacrificial material, wherein the intermixing layer has a gradient optical index matching material composition; and
etching the sacrificial material and a portion of the intermixing layer to form a porous, random, gradient optical index surface on the substrate.

2. The method of claim 1, wherein the depositing and co-depositing steps are performed in a vacuum.

3. The method of claim 1, wherein the depositing and co-depositing steps comprise physical deposition steps.

4. The method of claim 1, wherein, in the intermixing layer, the optical index matching material has a higher mass density adjacent to the optical index matching material and the substrate than adjacent to the sacrificial material.

5. The method of claim 1, wherein the sacrificial material forms a cap layer comprising only sacrificial material adjacent to the intermixing layer.

6. The method of claim 1, wherein the etching the sacrificial material and a portion of the intermixing layer comprises randomly etching the sacrificial material and a portion of the intermixing layer.

7. The method of claim 1, wherein the substrate comprises an inorganic optical substrate.

8. The method of claim 7, wherein the substrate comprises one of a crystalline, a polycrystalline, a dry, and a wet etch-resistant substrate.

9. The method of claim 1, wherein etching the sacrificial material and a portion of the intermixing layer comprises ion-etching the sacrificial material and a portion of the intermixing layer.

10. The method of claim 1, wherein the optical index of the optical index matching material is substantially different from an optical index of the sacrificial material.

11. A gradient-optical-index porous anti-reflective coating formed by a process, comprising:
providing a substrate;
depositing an optical index matching material on the substrate, wherein an optical index of the optical index matching material is substantially the same as an optical index of the substrate;
co-depositing a sacrificial material on the substrate and the optical index matching material to modulate the mass density of the optical index matching material in an intermixing layer between the optical index matching material and the sacrificial material, wherein the intermixing layer has a gradient optical index matching material composition; and
etching the sacrificial material and a portion of the intermixing layer to form a porous, random, gradient optical index surface on the substrate.

12. The coating of claim 11, wherein the depositing and co-depositing steps are performed in a vacuum.

13. The coating of claim 11, wherein the depositing and co-depositing steps comprise physical deposition steps.

14. The coating of claim 11, wherein, in the intermixing layer, the optical index matching material has a higher mass density adjacent to the optical index matching material and the substrate than adjacent to the sacrificial material.

15. The coating of claim 11, wherein the sacrificial material forms a cap layer comprising only sacrificial material adjacent to the intermixing layer.

16. The coating of claim 11, wherein the etching the sacrificial material and a portion of the intermixing layer comprises randomly etching the sacrificial material and a portion of the intermixing layer.

17. The coating of claim 11, wherein the substrate comprises an inorganic optical substrate.

18. The coating of claim 17, wherein the substrate comprises one of a crystalline, a polycrystalline, a dry, and a wet etch-resistant substrate.

19. The coating of claim 11, wherein etching the sacrificial material and a portion of the intermixing layer comprises ion-etching the sacrificial material and a portion of the intermixing layer.

20. The coating of claim 11, wherein the optical index of the optical index matching material is substantially different from an optical index of the sacrificial material.
